(19) United States
(12) Patent Application Publication
(10) Pub. No.: US 2020/0143453 A1
(43) Pub. Date: May 7, 2020

(54) Automated Window Estimate Systems and Methods

(71) Applicant: Christopher B Ripley, Lichtfield, CT (US)

(72) Inventor: Christopher B Ripley, Lichtfield, CT (US)

(21) Appl. No.: 16/178,577

(22) Filed: Nov. 1, 2018

(51) Int. Cl. G06Q 30/06; G06F 9/451; G06Q 30/02; G06F 3/0482; G06T 7/73

(52) U.S. Cl. CPC G06Q 30/0643; G06F 9/451; G06F 3/04845; G06F 3/0482; G06T 7/74; G06Q 30/0283

(57) ABSTRACT

In some embodiments, a computing device may include a camera and a processor coupled to the camera. The processor may be configured to control the camera to capture at least one image of a window and to automatically determine dimensions of the window based on the at least one image. The processor may be further configured to automatically determine costs of repair or replacement of the window in response to determining the dimensions.

### FIELD

The present disclosure is generally related to window repair and replacement, and more particularly to systems and methods configured to automate window estimates.

### BACKGROUND

Window replacement and window repair typically involve contacting a company that provides such services to arrange for the replacement or repair. For homes and businesses, a company may send an employee to visit the structure to measure windows manually and to provide a written estimate.

### SUMMARY

Embodiments of systems, methods, and devices are described below that enable a homeowner to use his or her smartphone or portable computing device to acquire an estimate of a cost of replacement or repair of an object, such as a window. In a particular embodiment, the device may include a display and a processor coupled to the display. The processor may provide graphical interface to the display to prompt the operator through a process of capturing an image of the object and, in response to capturing the image, the processor may determine dimensions of the object within the image and a cost of replacement or repair based on the determined dimensions.

In some embodiments, a system may include a network interface configured to communicate with a network and a processor coupled to the network interface. The processor may be configured to receive image data corresponding to a window from a computing device via the network and to automatically determine dimensions of the window in response to receiving the image data. Further, the processor may be configured to automatically determine costs associated with repair or replacement of the window based on the determined dimensions and to automatically provide an estimate for the repair or replacement of the window to the computing device through the network.

In other embodiments, a computing device may include a camera and a processor coupled to the camera. The processor may be configured to control the camera to capture at least one image of a window and to automatically determine dimensions of the window based on the at least one image. The processor may be further configured to automatically determine costs of repair or replacement of the window in response to determining the dimensions.

In still other embodiments, a system may include a computing device. The computing device can include a network interface configured to couple to a network, a camera, a display, and a processor coupled to the network interface, the camera, and the display. The processor may be configured to capture image data associated with a window using the camera and determine dimensions of the window based on the image data. The processor may be further configured to determine costs associated with repair or replacement of the window based on the determined dimensions and provide a graphical interface including the costs to the display.

### BRIEF DESCRIPTION OF THE DRAWINGS

FIG. 1 depicts a diagram of an operator using his or her handheld computing device, including an interface to automatically determine a cost of replacement or repair an object, to capture an image of a window, in accordance with certain embodiments of the present disclosure.

FIG. 2 depicts a block diagram of a system to automatically determine an estimate for repair or replacement of a window, in accordance with certain embodiments of the present disclosure.

FIG. 3 depicts a block diagram of a system including a computing device, such as smartphone, configured to automatically determine an estimate for repair or replacement of a window based on a picture of the window, in accordance with certain embodiments of the present disclosure.

FIG. 4 depicts a method of providing an estimate for repair or replacement of a window, in accordance with certain embodiments of the present disclosure.

FIG. 5 depicts a method of providing an estimate for repair or replacement of a window, in accordance with certain embodiments of the present disclosure.

FIG. 6 depicts a method of providing an estimate for repair or replacement of a window, in accordance with certain embodiments of the present disclosure.

FIG. 7 depicts a method of providing an estimate for repair or replacement of a window, in accordance with certain embodiments of the present disclosure.

FIG. 8 depicts a graphical interface including an image of a window and including instructions and selectable options accessible by an operator to determine an estimate for repair or replacement of the window, in accordance with certain embodiments of the present disclosure.

FIG. 9 depicts a graphical interface including an image of a window and including an adjustable shape accessible by an operator to determine an estimate for repair or replacement of the window, in accordance with certain embodiments of the present disclosure.

FIG. 10 depicts a graphical interface including an image of a window and including an adjustable shape that is rotatable and that is accessible by an operator to determine an estimate for repair or replacement of the window, in accordance with certain embodiments of the present disclosure.

FIG. 11 depicts a graphical interface including an image of a window and including an adjustable shape and a pull-down menu accessible by an operator to determine an estimate for repair or replacement of the window, in accordance with certain embodiments of the present disclosure.

FIG. 12 depicts a graphical interface including an image of a window and including an adjustable shape tracing an outline of the window and configured to determine an estimate for repair or replacement of the window, in accordance with certain embodiments of the present disclosure.

FIG. 13 depicts a graphical interface including selectable options accessible by an operator to configure window replacement or repair details, in accordance with certain embodiments of the present disclosure.

FIG. 14 depicts a graphical interface including selectable options accessible by an operator to provide contact information for the operator to receive an estimate, in accordance with certain embodiments of the present disclosure.

FIG. 15 depicts a graphical interface including details of an estimate for window replacement, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

Embodiments of systems, methods, and devices are described below that can be configured to automatically determine an estimate for replacement or repair of an item, such as a window. In some embodiments, a computing device (such as a smartphone) may include a window replacement estimate application that, when executed, may case the computing device to prompt the operator to take a picture of a window to be repaired or replaced. In response to capturing the picture, the computing device (e.g., the smartphone) may automatically determine the cost of repair or replacement.

In some embodiments, the window replacement estimate application may cause a processor of the computing device to determine dimensions of a window based on the picture or on a series of pictures. Optionally, the processor may utilize a reference item of known dimensions within the image to determine the dimensions of the window. In an example, the reference item may be a sheet of 8.5×11 inch copy paper, a ruler, paper money (such as a dollar bill or other bill), a coin, or another reference object. The application may further cause the processor to retrieve window replacement/repair data from one or more data sources and to apply the retrieved data to the determined dimensions to estimate the cost of repair or replacement. Other embodiments are also possible.

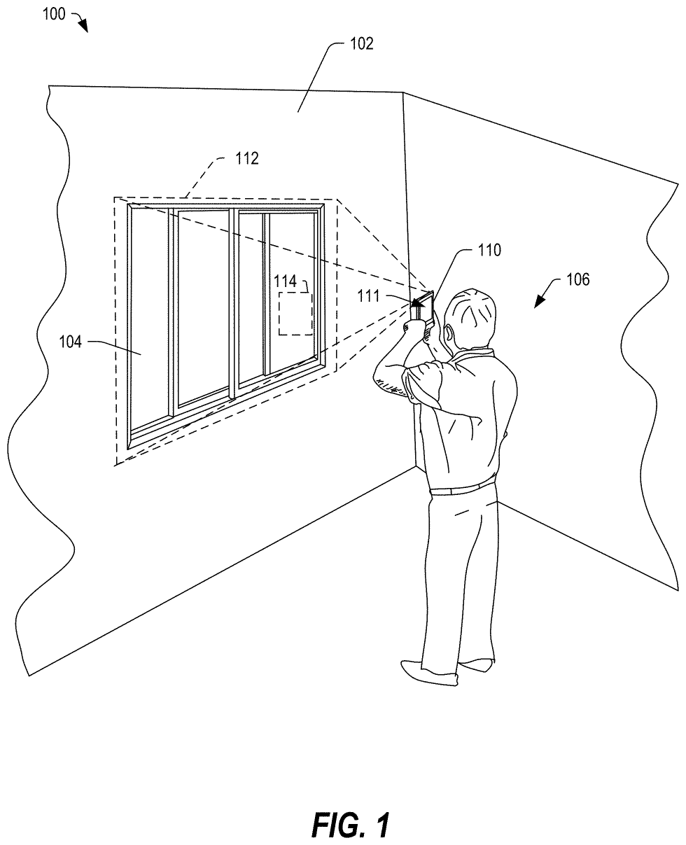

FIG. 1 depicts a diagram 100 of an operator 106 using his or her handheld computing device 110, including an interface to automatically determine a cost of replacement or repair an object, to capture an image 112 of a window 104, in accordance with certain embodiments of the present disclosure. In the illustrated example, the diagram 100 may include the window 104 installed in a wall 102.

The computing device 110 may be a smartphone, a tablet computer, or another portable computing device. The computing device 110 may include a processor, a memory, a display 111, and an input interface. In some embodiments, the display 111 and the input interface may be combined in the form of a touchscreen. Other embodiments are also possible.

The computing device 110 may present a graphical interface to the display 111. The graphical interface may include text to prompt the operator to capture in image of the window. In some embodiments, the graphical interface may include text to prompt the operator to place a reference item 114 (such as a sheet of 8.5×11 inch copy paper, a ruler, paper money (such as a dollar bill or other bill), a coin, or another reference object) on the window first. The graphical interface may also include one or more selectable elements accessible by the operator to select or confirm details of the window, to provide contact information, and to submit the information. Depending on the implementation, the graphical interface may be generated by an Internet browser application executing on the computing device 110 or may be presented by a window replacement estimate application executing on the computing device 110. Other embodiments are also possible.

In some embodiments, an operator may use his or her computing device 110 (such as the smartphone) to capture a picture (video or sequence of images) of a window as shown. The computing device 110 may communicate data related to the picture to a computer server associated with a window repair/replacement company. In some embodiments, the data may include dimensions of the window determined automatically by the computing device 110 based on the picture. The computer server may be configured to automatically generate an estimate for repair or replacement of the window in response to receiving the data, and to send the estimate to the computing device 110. The estimate may be sent as part of a graphical interface, which may be rendered by the estimate application or Internet browser application of the computing device 110.

In some embodiments, the system 100 may be configured to automate a process of acquiring an estimate for window replacement or repair. It should be understood that the system 100 may be used for a single window or for a plurality of windows. In a particular example, the system 100 could be used to determine the cost of replacing all of the windows of a house or a building. Other embodiments are also possible.

In a particular embodiment, the computing device 110 may be used to optically measure dimensions of the window 104 by orienting a camera of the computing device 110 toward a window to capture one or more images of the window. In one example, the operator may align a dot or reticle with a corner of the window and touch the touchscreen display to place an object, for example, at the corner of the window. The operator may then reorient the computing device 110 toward an adjacent corner of the window and touch the touchscreen display to place a second object. In this example of object placement, the object may be centered within the display and the user may orient his or her device to align the center of the display with the location on the frame before tapping the display. The process may be repeated until the operator has traced an outline of the window. During the placement operations, the computing device 110 may determine orientation and motion data and may utilize the orientation and motion data to determine a distance between the placed objects.

In another particular embodiment, the user may take a picture and then drop one or more objects or shapes onto the picture by tapping the touchscreen display 111. The operator may then interact with the one or more objects or shapes to trace the outline of the object within the picture. In some embodiments, the computing device 110 may automatically determine dimensions of the object, such as a window, based on the traced outline of the object within the picture. Other embodiments are also possible.

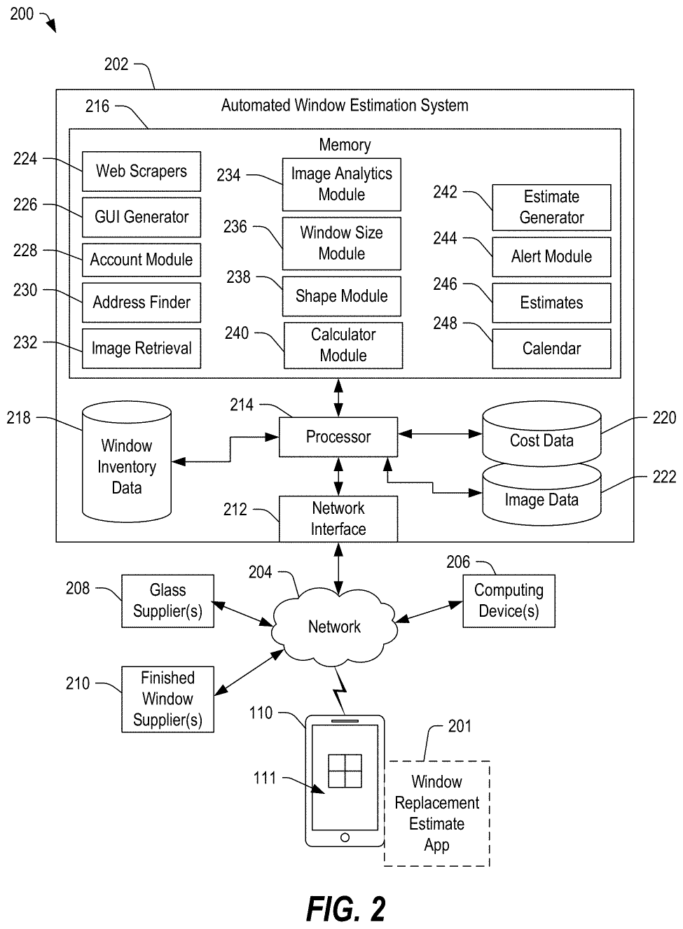

In another possible embodiment, an operator may utilize the computing device 111 to capture an image of the window and may utilize a measurement application to measure the window. The measurements and the image may be sent to an automated window estimation system (such as the system 202 in FIG. 2) to automatically determine a cost estimate for repair or replacement of the window. In another embodiment, the measurements and the image may be processed locally, within the computing device 110, to determine a cost estimate based on retrieved or locally stored pricing data. Other embodiments are also possible.

In one possible embodiment, when taking a picture of the window, the graphical interface may prompt the operator to center the object within a box or between guide marks presented within the graphical interface. The computing device may automatically capture a sequence of pictures over a brief span of time. Concurrently, motion sensors, orientation sensors, or any combination thereof may sense movement of the computing device. In an example, small movements of the operator's hands (e.g., jitter or other movement) can be captured from frame to frame, optically. The processor of the computing device may correlate each image to its corresponding orientation and motion data, and may be configured to determine a distance between the camera and the object based on the optical changes relative to the orientation and motion data. Further, the processor may be configured to determine the size of the object based on the determined distance and at least one of the images. In this example, the determined size may be an initial size determination that can be refined by placing objects or tracing the window as described above. Other embodiments are also possible.

In another embodiment, the operator may place a reference object, such as a sheet of copy paper, on the window and then take a picture of the window. The processor of the computing device may be configured to determine the dimensions of the window based on the reference object. Other embodiments are also possible.

FIG. 2 depicts a block diagram of a system 200 to automatically determine an estimate for repair or replacement of a window, in accordance with certain embodiments of the present disclosure. The system 200 may include an automated window estimation system 202 configured to communicate through a network 204 with the computing device 110, with one or more other computing devices 206, with one or more glass suppliers 208, with one or more finished window suppliers 210, with other devices or systems, or any combination thereof.

In some embodiments, the computing device 110 may store a window replacement estimate application 201 in memory and which may execute the application 201 to provide a graphical interface to a display 111. Alternatively, the computing device 110 may executed an Internet browser application, which may provide the graphical interface to the display 111. Other embodiments are also possible.

In some embodiments, the automated window estimation system 202 may include a network interface 212 coupled to the network 204. Further, the system 202 may include a processor 214 coupled to the network interface 212. The system 202 may also include a memory 216, window inventory data 218, cost data 220, and image data 222, each of which may be coupled to the processor 214. The memory 216 may be configured to store data and instructions that, when executed, may cause the processor 214 to determine the cost of window replacement or repair.

The memory 216 can include one or more web scrapers 224 that, when executed, may cause the processor 214 to retrieve glass price and available inventory information from the one or more glass suppliers 208 and to retrieve finished window price and available inventory information from the one or more finished window suppliers 210. The information may be stored in window inventory data 218 and cost data 220. The memory 216 may further include a graphical user interface (GUI) generator 226 that, when executed, may cause the processor 214 to generate a graphical interface including inventory data, cost data, other data, or any combination thereof. In some embodiments, the GUI generator 226 may also cause the processor 214 to generate a graphical user interface including information and instructions to prompt an operator through a process of capturing images of objects to be replaced or repaired and to provide cost estimates.

The memory 216 may further include an account module 228 that, when executed, may cause the processor 214 to authenticate a particular user. In some embodiments, the account module 228 may cause the processor 214 to associate images from a computing device of a user with the user's account. The account data may be stored in the memory 216.

The memory 216 can include an address finder module 230 that, when executed, may cause the processor 214 to utilize address information received from the operator to determine pricing and other information based on the geographic location. The memory 216 can include an image retrieval module 232 that, when executed, may cause the processor 214 to receive image data from the computing device 110 or from another source. The image data may include a sequence of pictures or video frames of the object, such as a window, and correlated motion and orientation data for each picture or video frame. In some embodiments, the image data may include a single image that includes both the window and a reference object. Other embodiments are also possible.

The memory 216 may further include an image analytics module 234 that, when executed, may cause the processor 214 to analyze the received images to extract shapes and other information from the image data, such as object boundary information, reference object information, and so on. In an example, the image analytics module 234 may cause the processor 214 to identify the reference object 114 in the image data. In some embodiments, a window may include multiple panes, and the image analytics module 234 may cause the processor 214 to determine changes in the position of an object within the received images from image to image and relative to the motion and orientation data to determine a distance between the object and the camera that captured the images. In one possible embodiment, the image data may include a sequence of pictures over a brief span of time (e.g., 3 or 5 pictures taken a few milliseconds apart). The data sent to the automated window estimation system 202 may include motion/orientation data correlated to the sequence of pictures. The images and the motion/orientation data may reflect small movements of the operator's hands (e.g., jitter or other movement). Other embodiments are also possible.

Further, the memory 216 may include a window size module 236 that, when executed, may cause the processor 214 to determine dimensions of a window (or a plurality of windows) based on the image data and based on the determined distance. In some embodiments, the dimensions may be determined, at least in part, based on shape data included within the image data. The window size module 236 may cause the processor 214 to determine the size of the object based on the one or more images. In some embodiments, the size may be determined based on the reference object within the image and based on determined boundaries of the object within the image. The boundaries may be determined automatically or based on one or more shape objects placed onto the image and adjusted to fit the boundaries using the graphical interface. In some embodiments, the window size module 236 may determine the size based on a determined distance between the camera and the object. The determined size, at this point, may reflect an initial size estimate, which may be refined using shape objects. Other embodiments are also possible.

The memory 216 can include a shape module 238 that, when executed, may cause the processor 214 to determine provide adjustable shape objects for insertion within the graphical interface. The operator may click on an image within the graphical interface to place a shape object onto an image and may manipulate the shape object within the graphical interface to expand, rotate, or otherwise adjust the shape to outline the particular window within the image to be repaired or replaced. The window size module 236 may utilize the shape data from the shape module to determine the outline of the window, and the outline may be used by the window size module 236 to refine the initial size estimate to determine dimension data associated with the window. Further, the memory 216 can include a calculator module 240 that, when executed, may cause the processor 214 to determine a cost estimate for each window based on the dimension data.

In one possible embodiment, the image analytics module 234 may cause the processor 214 to determine a reference object within the image and to determine dimensions of the reference object. Further, the image analytics module 234 may cause the processor 214 to automatically determine boundaries of the window within the image. The window size module 236 may cause the processor 214 to automatically calculate dimensions of the window based on the known dimensions of the reference object and based on the automatically determined boundaries of the window. This initial estimate may be refined based on shape objects placed on the image and adjusted by the operator to determine the actual size of the window.

The memory 216 may further include an estimate generator 242 that, when executed, may cause the processor 214 calculate an estimate for window replacement or repair. The estimate generator 242 may utilize the cost information as well as inventory, quantity information, and other information to determine a cost estimate.

The memory 216 may also include an alert generator 244 that, when executed, may cause the processor 214 to generate an alert, such as an email, a text, another message, or any combination thereof. Further, the alert may include a link to a graphical interface that can be accessed by the operator via an application executing on his computing device 110 or 206.

The memory 216 can further include a plurality of estimates 246, each of which may be associated with a particular address or a particular operator. Further, the memory 216 may include a calendar module 248 that, when executed, may cause the processor 214 to manage schedules for a plurality of installers with respect to each address. In an example, the calendar module 248 may cause the processor 214 to present information, including available dates to schedule installation of the windows, to the operator within a graphical interface. Other embodiments are also possible.

In this example, a portable computing device 110 or 206 may capture one or more pictures associated with one or more windows and may provide data related the one or more windows to the automated window estimation system 202 through a network 204. The data can include dimensions of each of the one or more windows and optionally the images. In some embodiments, the data may include the image data including the window and a reference object, such as a standard sheet of copy paper.

In response to receiving the data, the automated window estimation system 202 may be configured to automatically determine costs (material and labor) associated with the repair or replacement of the one or more windows. In some embodiments, the automated window estimation system 202 may automatically determine the dimensions of each of the one or more windows based on the image data and may determine the costs based on the dimensions. Further, the automated window estimation system 202 may generate a quote for the requested service and may transmit the quote to the computing device 110 or 206 through the network 206. In some embodiments, the quote may be included within a graphical interface.

In response to receiving the graphical interface, the computing device 110 or 206 may present the graphical interface to a display. The graphical interface may include selectable options accessible by the operator to schedule the installation. If the operator selects the selectable option to schedule the installation, the graphical interface may request available date information from the automated window estimation system 202 and may facilitate interactions between the operator and the automated window estimation system 202 to schedule the installation.

In some embodiments, the automated window estimation system 202 may facilitate the estimation and installation of windows for multiple customers (operators) and may coordinate with installers to schedule the installation. In one possible embodiment, the automated window estimation system 202 may be configured to determine a plurality of available installers for repairing or replacing the customer's windows and may present the possible installers as selectable options within the graphical interface to allow the operator to select one. In another possible embodiment, the automated window estimation system 202 may be configured to communicate the offer to multiple installers. Other embodiments are also possible.

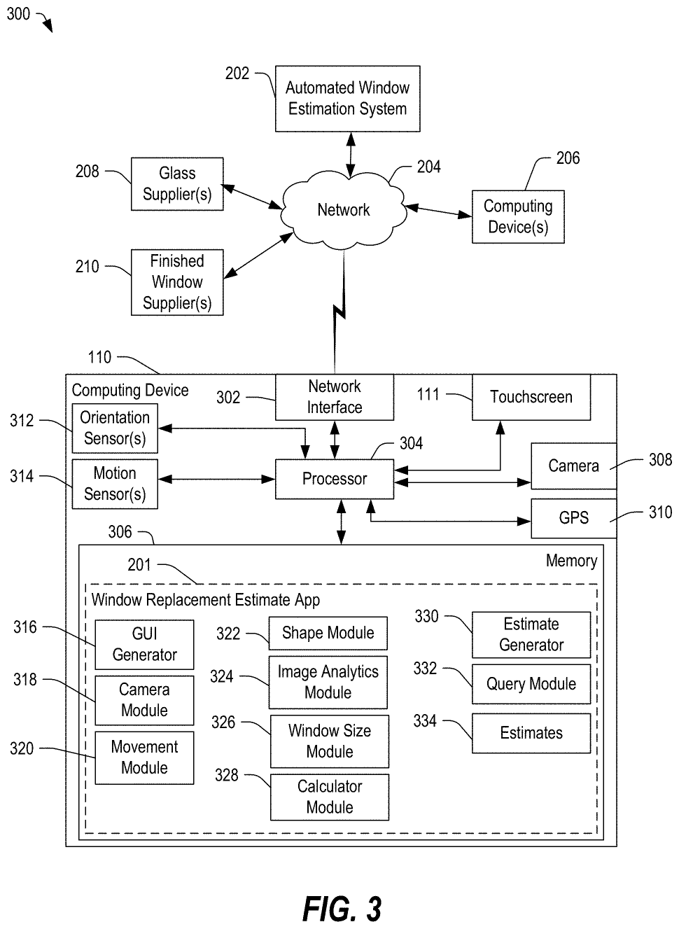

FIG. 3 depicts a block diagram of a system 300 including a computing device 110, such as smartphone, configured to automatically determine an estimate for repair or replacement of a window based on a picture of the window, in accordance with certain embodiments of the present disclosure. The system 300 may be an embodiment of the systems 100 and 200 of FIGS. 1 and 2, respectively.

The system 300 may include the automated window estimation system 202 configured to communicate with the computing device 110, one or more computing devices 206, one or more glass suppliers 208, and one or more finished window suppliers 210 through the network 204. The computing device 110 may include a network interface 302 configured to couple to the network 204. The computing device 110 may further include a processor 304 coupled to the network interface 302. The computing device 110 may further include a memory 306, a camera 308, a global positioning satellite (GPS) circuit 310, one or more orientation sensors 312, one or more motion sensors 314, and a touchscreen 111, each of which may be coupled to the processor 304.

The memory 306 may store data and may store instructions that, when executed, may facilitate acquisition of an estimate for window repair and replacement based on a picture of the window. The memory 306 may store a window replacement estimate application 201 that, when executed, may cause the processor 304 to provide a graphical interface including instructions to prompt an operator to capture a picture of a window and to automatically determine a cost or repair or replacement of the window based on the picture. In some embodiments, the instructions may also prompt the operator to place a reference object on the window prior to taking the picture. Other embodiments are also possible.

The window replacement estimate application 201 may include a graphical user interface (GUI) generator 316 that, when executed, may cause the processor 304 to generate a graphical interface and to provide the graphical interface to the touchscreen 111. The window replacement estimate application 201 may further include a camera module 318 that, when executed, may cause the processor 304 to control the camera 308 to capture one or more images of a window. The memory 306 may also include a movement module 320 that, when executed, may cause the processor 304 to receive GPS data from the GPS circuit 310, orientation data from the orientation sensors 312, and motion data from the motion sensors 314.

The memory 306 can include a shape module 322 that, when executed, may cause the processor 304 to insert one or more shape objects (such as adjustable rectangles) into the graphical interface and superimposed over at least one of the images, for example, in response to a user interaction with the graphical interface. The memory 306 can further include an image analytics module 324 that, when executed, may cause the processor 304 to determine information about an object, such as a window, within the image based on the shape objects, based on a reference object within the image, based on other data determined from the image, or any combination thereof. In some embodiments, the determined information can include relative movement of an object within the image from frame to frame in a sequence of images (taken milliseconds apart), which movement may reflect jitter or other movement of the operator. The image analytics module 324 may cause the processor 304 to use the relative motion of the object within the images from frame-to-frame as compared to the motion data from the motion sensors 314 and orientation from the orientation sensors 312 to determine a distance between the object and the camera 308. In some embodiments, the image analytics module 324 may automatically detect boundaries of the object based on the image.

The memory 306 may further include a window size module 326 that, when executed, may cause the processor 304 to determine a size of a window based, at least in part, on the image data. The window size module 326 may cause the processor 304 to automatically estimate the dimensions of the object based on the boundaries, the dimensions of a reference object within the image, the determined distance between the object and the camera, angles relative to a center of the image, or any combination thereof. In some embodiments, the shape objects can be used by the window size module 326 to refine the automatically calculated dimensions of the window.

In a particular embodiment, the window size module 326 may cause the processor 304 to determine the size of the window based on the optical changes determined by the image analytics module 234 relative to the changes in the physical orientation of the device. In a particular example, as the camera 308 captures the image of the window, the camera 308 may capture several images (such as a short video (e.g., a few milliseconds) or a sequence of images captured over a few milliseconds). The motion and orientation sensors may capture corresponding motion and orientation data, which can be correlated with the frames of the video or the images. The image analytics module 326 may cause the processor 304 to determine the distance between the camera 308 and the window based on changes within the image data relative to the sensed movement and then may calculate the dimensions of the window from the image using the distance information. Other embodiments are also possible.

The memory 306 may further include a calculator module 328 that, when executed, may cause the processor 304 to calculate or estimate the cost of repair or replacement of the window based on the determined dimensions. The calculator module 328 may cause the processor 304 to calculate costs based on a variety of different options and based on the dimensions of each window. The resulting cost estimates may provide options from which the operator may choose. Other embodiments are also possible.

The memory 306 can further include an estimate generator 330 that, when executed, may cause the processor 304 to determine an estimate for the window repair or replacement (materials and labor). The estimate may include the estimated unit and labor costs, any discounts or adjustments, and so on. The memory 306 may include a query module 332 that, when executed, may cause the processor 304 to communicate data related to the window to an automated window estimation system 202 to retrieve cost data, which can be used to determine the costs and the estimate. The memory 306 can also store estimates 334. Other embodiments are also possible.

In an example, the computing device 110 may be accessed by the operator to execute the window replacement estimate application 201. Once executed, the application 201 may cause the computing device 110 to provide a graphical interface to the touchscreen 111 to guide the operator to capture a picture of a window and optionally to place a reference object on the window prior to capturing the picture. In response to receiving the picture, the window replacement estimate application 201 may be configured to automatically determine dimensions of the window and a cost for repair or replacement of the window. Further, the window replacement estimate application 201 may cause the processor to provide a graphical interface including a cost estimate to the touchscreen 111. The graphical interface may also include a selectable option accessible by an operator to accept the estimate, to scheduling the repair, and so on. Other embodiments are also possible.

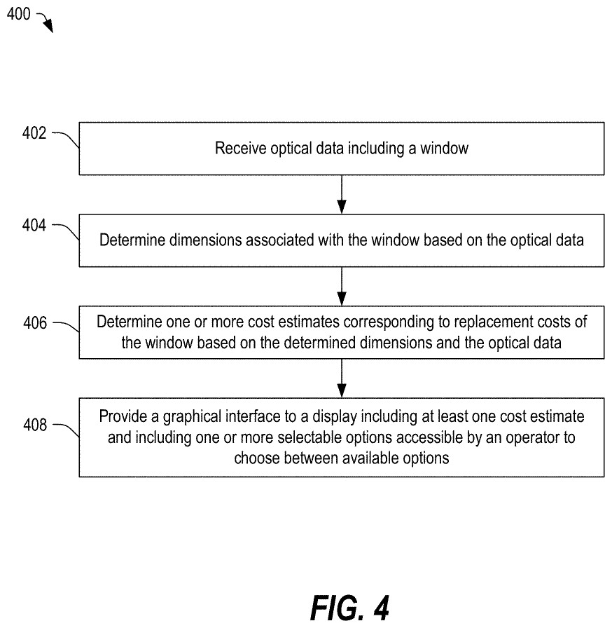

FIG. 4 depicts a method 400 of providing an estimate for repair or replacement of a window, in accordance with certain embodiments of the present disclosure. At 402, the method 400 can include receiving optical data including a window. The optical data may be received from a computing device through a network or may be received by a processor from a camera.

At 404, the method 400 can include determining dimensions associated with the window based on the optical data. The dimensions may be determined in a variety of ways. In one possible example, the dimensions may be determined automatically by processing the image data. In some examples, the image data may include a reference object from which the dimensions of the window may be determined. The reference object can include a sheet of 8.5×11 inch paper, a ruler, paper currency, a coin, another reference object, or any combination thereof. In a particular example, the user may take a picture, measure the horizontal distance from the object being photographed, and enter the distance information. The processor may then automatically determine the dimensions of the window based on geometric principles. In some embodiments, after the initial dimensions are calculated, the user may access the graphical interface to place shape objects on the photograph and then interact with them to resize and otherwise adjust the shape objects to provide an outline of the object (e.g., the window). The computing device may be configured to determine the dimensions based on pixels in the photograph and based on the objects relative to the previously determined dimensions. Other embodiments are also possible.

At 406, the method 400 may include determining one or more cost estimates corresponding to replacement (or repair) costs of the window based on the determined dimensions and the optical data. In some embodiments, the computing device may determine the one or more cost estimates by retrieving data from one or more data sources through a network, by retrieving data from a local database, or any combination thereof.

At 408, the method 400 may include providing a graphical interface to a display including at least one cost estimate and including one or more selectable options accessible by an operator to choose between available options. In an example, the options may include different types of windows, different types or brands of glass, and so on. Other embodiments are also possible.

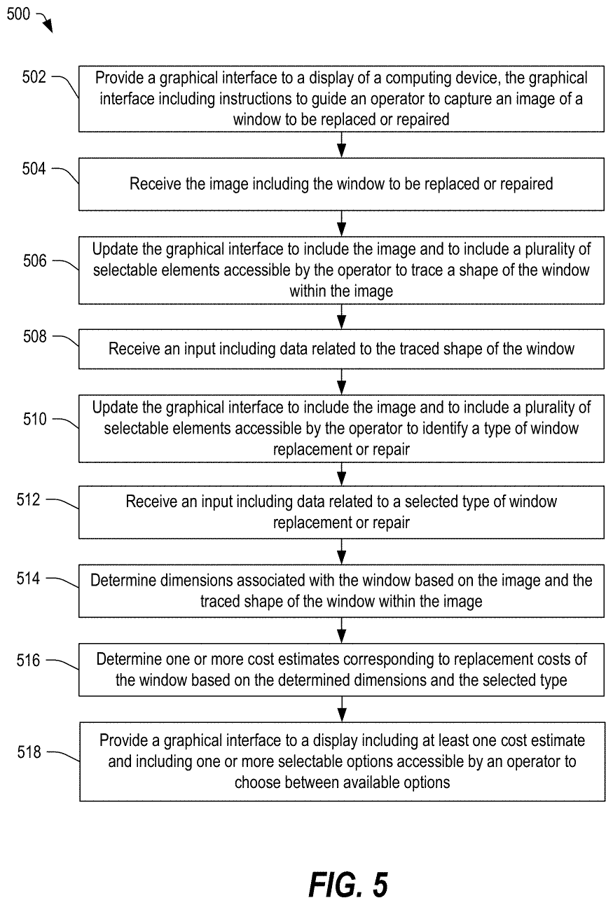

FIG. 5 depicts a method 500 of providing an estimate for repair or replacement of a window, in accordance with certain embodiments of the present disclosure. At 502, the method 500 may include providing a graphical interface to a display of a computing device, where the graphical interface includes instructions to guide an operator to capture an image of a window to be replaced or repaired. In some embodiments, the graphical interface may be sent to a computing device through a network.

At 504, the method 500 can include receiving the image including the window to be replaced or repaired. In one embodiment, the image may be received by a processor of the computing device. In another embodiment, the image may be received from the computing device at an automated window estimate system through a network.

At 506, the method 500 can include updating the graphical interface to include the image and to include a plurality of selectable elements accessible by the operator to trace a shape of the window within the image. At 508, the method 500 may include receiving an input including data related to the traced shape of the window. In some embodiments, the data may include dimensions of the window. In other embodiments, the data may include pixel positions of one or more shapes used to trace the window. Other embodiments are also possible.

At 510, the method 500 may include updating the graphical interface to include the image and to include a plurality of selectable elements accessible by the operator to identify a type of window replacement or repair. The selectable elements may be accessible by the operator to select between window types and optionally to select between estimates. Other embodiments are also possible.

At 512, the method 500 can include receiving an input including data related to a selected type of window replacement or repair. The type can include double-hung windows, casement windows, picture windows, and the like. Additionally, the data can include not only the type of window but also other selections.

At 514, the method 500 may include determining dimensions associated with the window based on the image and the traced shape of the window within the image. The dimensions may be determined according to any of the above-described processes, depending on the implementation. At 516, the method 500 can include determining one or more cost estimates corresponding to the replacement costs of the window based on the determined dimensions and the selected type. At 518, the method 500 may include providing a graphical interface to a display including at least one cost estimate and including one or more selectable options accessible by an operator to choose between available options.

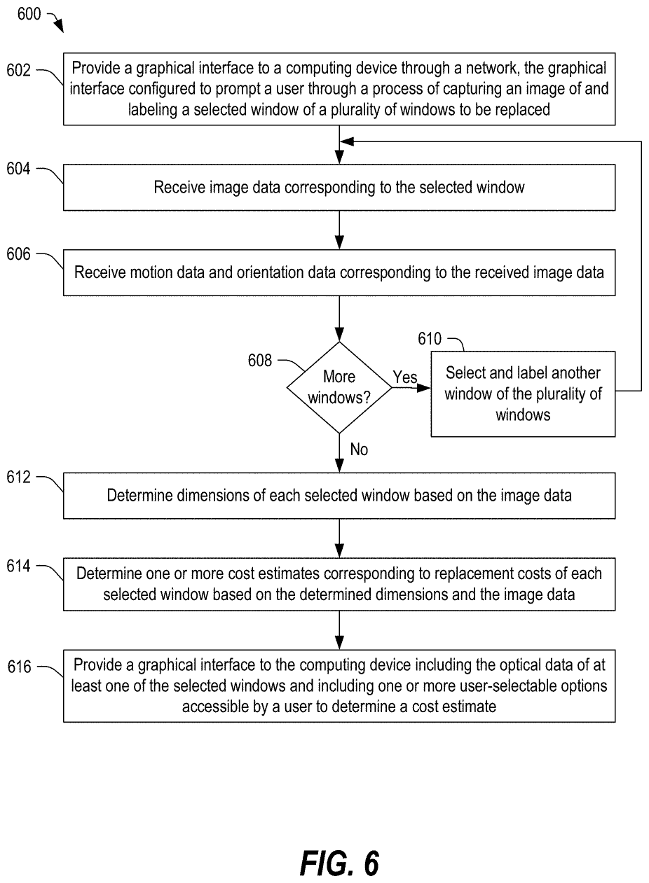

FIG. 6 depicts a method 600 of providing an estimate for repair or replacement of a window, in accordance with certain embodiments of the present disclosure. At 602, the method 600 can include providing a graphical interface to a computing device through a network, the graphical interface configured to prompt a user through a process of capturing an image of and labeling a selected window of a plurality of windows to be replaced. In an example, the operator may utilize his or her smartphone to capture an image of a window and to label the picture (e.g., “Living Room #1”) and then to move on to capture a next window, labeling each picture so that the window and its replacement can be easily matched. In some embodiments, each image may include a reference object as well as the window.

At 604, the method 600 can include receiving image data corresponding to the selected window. At 606, the method 600 can include receiving motion data and orientation data corresponding to the received image data.

At 608, if there are more windows, the operator may interact with the computing device to select and label another window of the plurality of windows, at 610. The method 600 may then return to 604 to receive image data corresponding to the selected window.

Returning to 608, if there are no more windows to be repaired or replaced, the method 600 may include determining dimensions of each selected window based on the image data, at 612. In some embodiments, the reference object is used to determine the dimensions of the window (either based on automatic detection of the window or based on shape objects placed and sized to fit the outline of the window). In some embodiments, the received image data may include a plurality of images or video frames captured over a few milliseconds. The computing device may determine the distance between the camera of the computing device and each window based on relative position of various features of the image from image to image relative to the motion and orientation data. The computing device may then determine the size of each window based on the image data and the determine distance.

At 614, the method 600 may include determining one or more cost estimates corresponding to replacement costs of each selected window based on the determined dimensions and the image data. At 616, the method 600 can include providing a graphical interface to the computing device including the optical data of at least one of the selected windows and including one or more user-selectable options accessible by a user to determine a cost estimate.

In some embodiments, the operator may interact with the graphical interface to schedule the replacement or repair. Other embodiments are also possible.

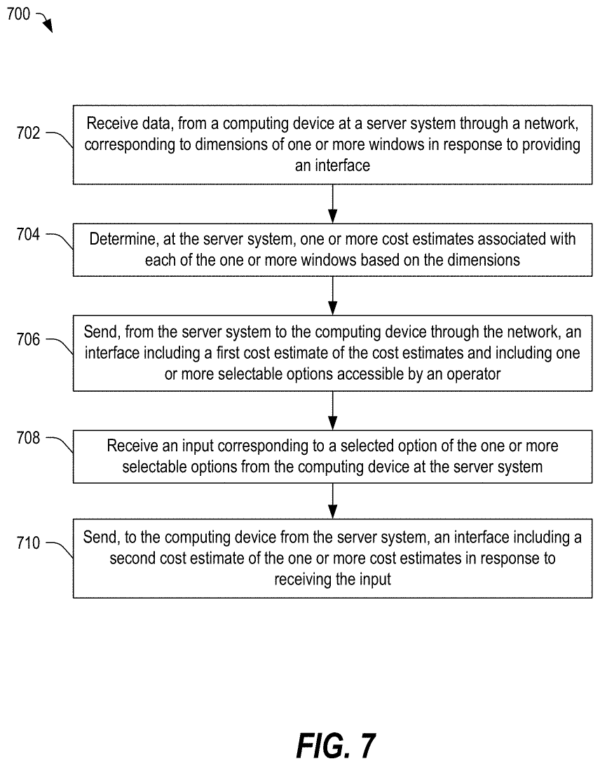

FIG. 7 depicts a method 700 of providing an estimate for repair or replacement of a window, in accordance with certain embodiments of the present disclosure. At 702, the method 700 can include receiving data, from a computing device at a server system through a network, corresponding to dimensions of one or more windows in response to providing an interface. At 704, the method 700 may include determining, at the server system, one or more cost estimates associated with each of the one or more windows based on the dimensions. In a particular example, the system may search one or more data sources to determine costs of materials and costs of labor for producing the cost estimates. Other embodiments are also possible.

At 706, the method 700 can include sending, from the server system to the computing device through the network, an interface including a first cost estimate of the cost estimates and including one or more selectable options accessible by an operator. At 708, the method 700 may include receiving an input corresponding to a selected option of the one or more selectable options from the computing device at the server system. At 710, the method 700 can include sending, to the computing device from the server system, an interface including a second cost estimate of the one or more cost estimates in response to receiving the input. Other embodiments are also possible.

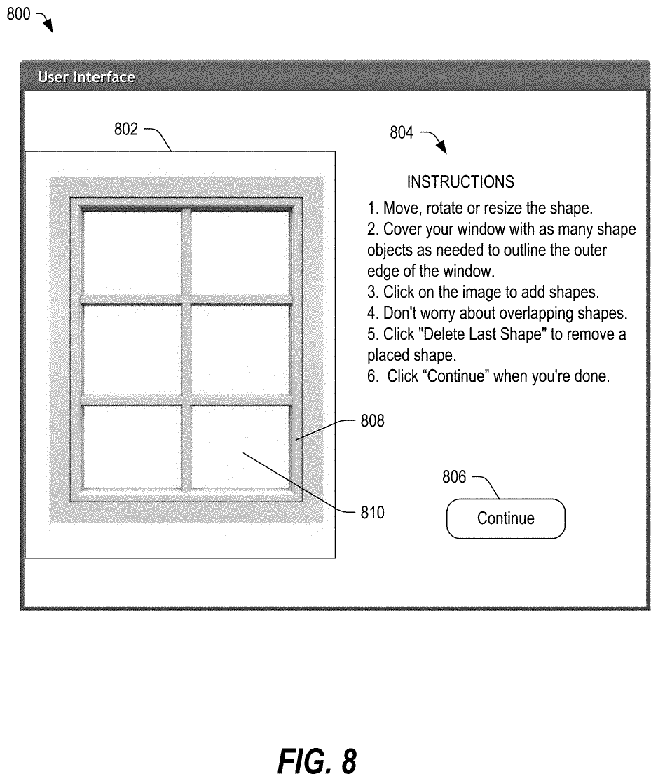

FIG. 8 depicts a graphical interface 800 including an image of a window and including instructions 804 and selectable options 806 accessible by an operator to determine an estimate for repair or replacement of the window, in accordance with certain embodiments of the present disclosure. The graphical interface 800 may include a frame or box 802 within which the window 810 may be centered during an image capture operation. It should be appreciated that the window 810 is a different type of window from that depicted in FIG. 1.

In the illustrated example, an empty frame 802 may be provided and the live images from the camera may be presented within the frame 802. In this example, the computing device is oriented such that the window 810 and its window frame 808 are centered within the frame 802. The graphical interface 800 can further include a selectable option, such as a “Continue” button 806. Other embodiments are also possible.

In some embodiments, the image of the window 810 can be captured together with a reference object, such as a piece of paper of standard size, paper currency, a ruler, a coin, another object, or any combination thereof. The computing device may automatically determine the boundaries of the window or may determine the boundaries based on one or more shape objects placed on the image and sized to match the boundaries. The computing device may then determine the dimensions of the window based on the reference object and the boundaries. Other embodiments are also possible.

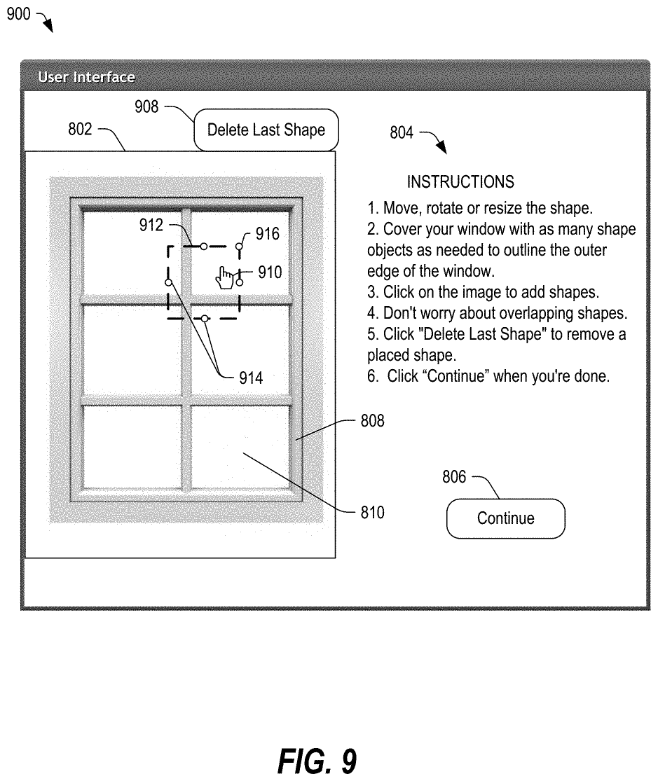

In some embodiments, as the operator captures the image of the window 810, the computing device may capture a sequence of images or a video including multiple frames captured over a few milliseconds. The computing device may determine initial dimensions of the window 810 based on changes in the position of the window 810 within the frame 802 from frame to frame as compared to the orientation and motion data from the sensors. Small changes in orientation may demonstrate changes in the relative position of the window 810 based on the operator's distance from the window 810. The determined distance can then be used to automatically determine initial dimensions of the window 810. The initial dimensions of the window 810 can be refined by tracing the outline of the window 810 as described below with respect to FIGS. 9-12.

FIG. 9 depicts a graphical interface 900 including an image of a window and including an adjustable shape accessible by an operator to determine an estimate for repair or replacement of the window, in accordance with certain embodiments of the present disclosure. The graphical interface 900 includes all of the elements of the graphical interface 800 of FIG. 8. Additionally, the graphical interface 900 includes a shape object 912, which can be dropped or placed onto the image of the window 810 within the frame 802 by clicking, selecting, touching, or otherwise interacting with the image within the frame 802. The graphical interface 900 may further include a “Delete Last Shape” button 908, which may appear after a first shape object 912 is placed.

A square shape may be a default shape object 912. The shape object 912 includes selectable edge elements 914 and at least one selectable corner element 916. A pointer object 910 is shown that may represent a position of a mouse pointer or a touch location on a touch screen where the operator touched within the image.

As previously discussed, the automatic dimension determination may rely on automated boundary detection or other image processing techniques, which may have a margin of error. The error margin can be reduced by resizing the dimensions according to the shape objects that are placed and sized to fit the window. Other embodiments are also possible.

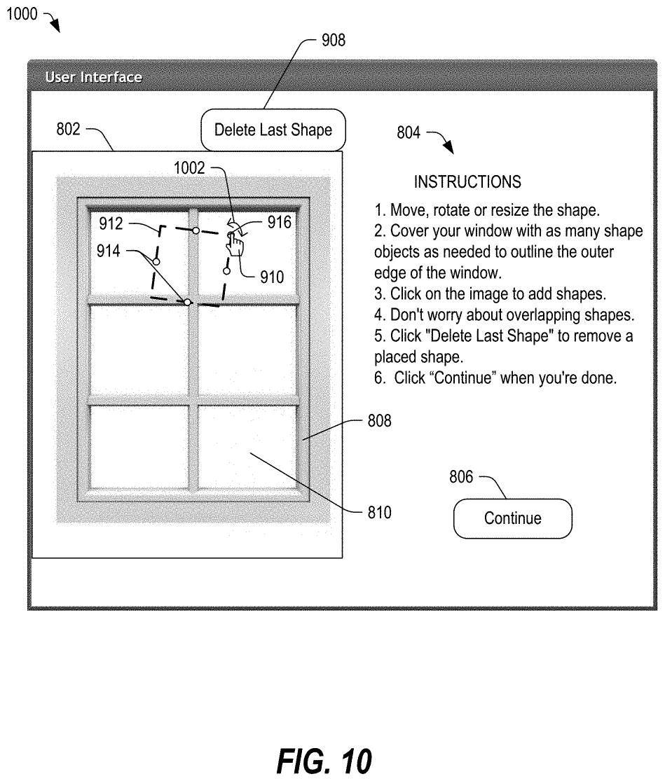

In the illustrated example, each edge element 914 may be selected by the operator to drag and drop the edge to resize the shape object 912. The corner element 916 may be selected to rotate the shape object 912 as depicted in FIG. 10.

FIG. 10 depicts a graphical interface 1000 including an image of a window 810 and including an adjustable shape object 912 that is rotatable and that is accessible by an operator to determine an estimate for repair or replacement of the window, in accordance with certain embodiments of the present disclosure. The graphical interface 1000 includes all of the elements of the graphical interface 900. The shape object 912 can be rotated, as indicated by the curved arrow 1002 by selecting the corner element 916 using the pointer object 910 and by dragging and releasing the corner element 916.

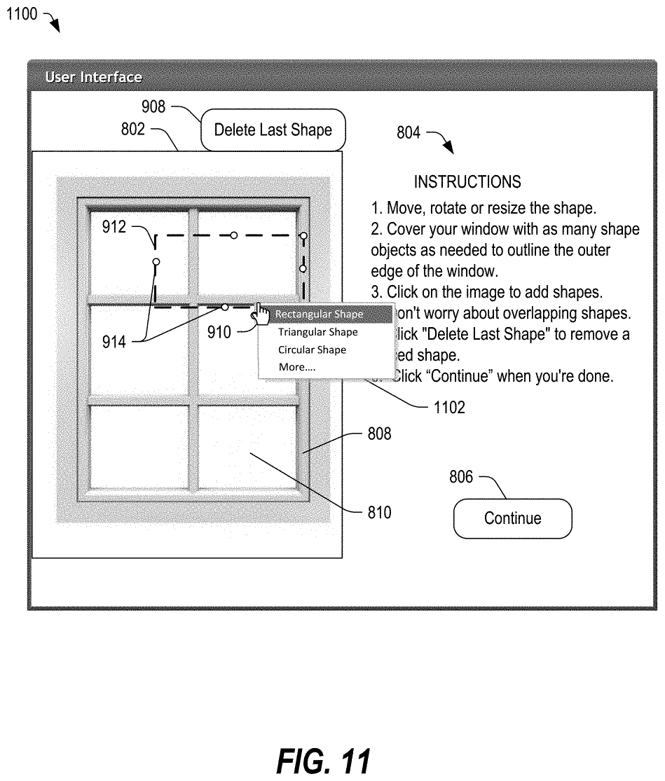

In the illustrated example, the image of the window 810 is rectangular and is arranged vertically, so rotation of the shape object 912 is not necessary. However, other images may be misaligned, and some windows may have different shapes, which may not be rectangular. In the event that the window has a triangular feature or a diamond shape, the shape object 912 may be resized and rotated to match the edges of the window. Other shapes are also possible. One possible example of a shape object 912 that can be changed to a different shape is described below with respect to FIG. 11.

FIG. 11 depicts a graphical interface 1100 including an image of a window 810 and including an adjustable shape 912 and a pull-down menu 1102 accessible by an operator to determine an estimate for repair or replacement of the window, in accordance with certain embodiments of the present disclosure. The graphical interface 1100 includes all of the elements of the graphical interface 1000 of FIG. 10. Additionally, the graphical interface 1100 may include a pull-down menu 1102 that can be accessed by right-clicking or otherwise selecting the shape object 912 to select between available shapes. In this example, the pull-down menu 1102 may include a rectangular shape option, a triangular shape option, a circular shape option, other options, or any combination thereof. In some embodiments, the triangular shape options may be more specific, such as “Right Triangle”, “Isosceles Triangle”, and so on.

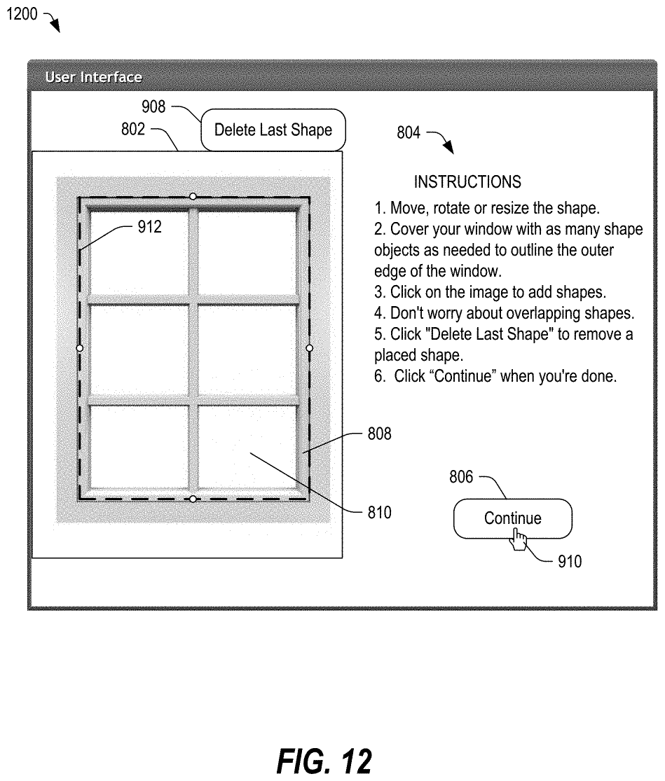

FIG. 12 depicts a graphical interface 1200 including an image of a window 810 and including an adjustable shape 912 tracing an outline of the window 810 and configured to determine an estimate for repair or replacement of the window 810, in accordance with certain embodiments of the present disclosure. The graphical interface 1200 depicts the window 810 with the shape object 912 stretched to fit an outline of the window 810.

It should be appreciated that the initial estimate of the dimensions of the window 810 may be determined by comparing relative movement of the window 810 within a sequence of images or within a sequence of frames of a video to the orientation and motion data from the sensors to determine a distance between the window and the camera. Once the distance is determined, the dimensions of the window can be estimated by determining the boundaries of the shape object and the relative size of the object within the image given the determined distance. The initial estimate of the dimensions of the window 810 may be refined based on the shape object 912 to prove the dimensions that can be used to estimate the costs. Other embodiments are also possible.

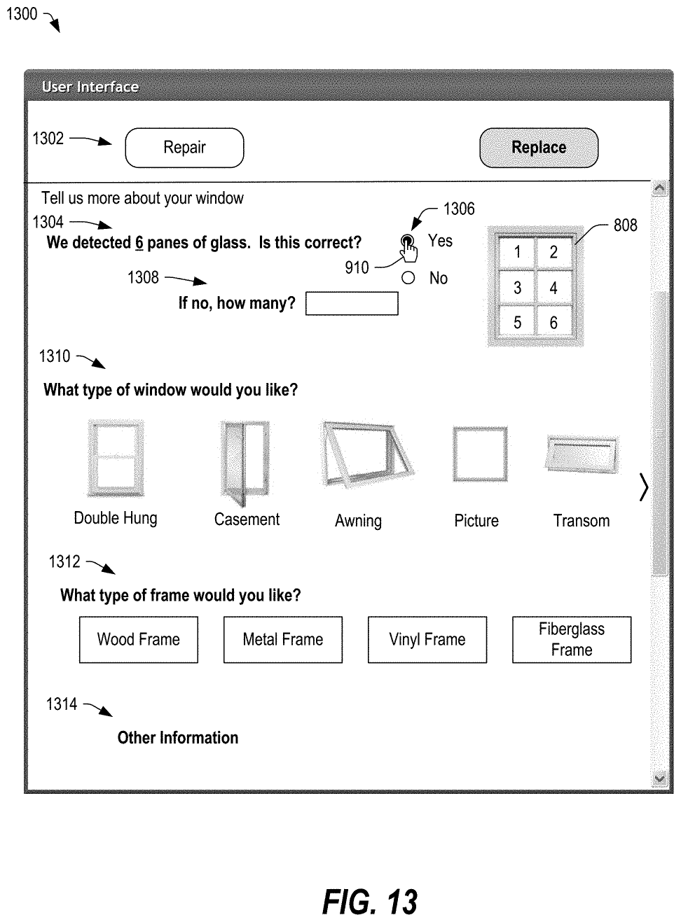

It should be appreciated that the dimensions of the window 810 represent one of several parameters that may determine the cost of repair or replacement. Other parameters that can impact the cost may include the location (e.g., address of the customer), the number of panes of glass, the type of window, the type of frame, and so on. Additionally, it may be less expensive to repair a broken window than to replace the window. One possible example of a graphical interface to capture additional parameters for determining the cost of repair or replacement of a window are described below with respect to FIG. 13.

FIG. 13 depicts a graphical interface 1300 including selectable options accessible by an operator to configure window replacement or repair details, in accordance with certain embodiments of the present disclosure. The graphical interface 1300 may be presented to the operator upon selection of the “Continue” button 806.

The graphical interface 1300 can include a selectable options 1302 accessible by an operator to specify whether the operator wants to repair or replace the window. The selectable options 1302 are depicted as a “Repair” button and a “Replace” button. The “Replace” button is selected. In other embodiments, radio buttons or other selectable options may be included.

The graphical interface 1300 may include a request 1304 to confirm a number of panes, including radio buttons 1306 to indicate whether the determined number of panes (in this case “6”) is correct. If not, a text field 1308 is provided to specify a number of panes. Further, the graphical interface 1300 may include selectable options 1310 to specify a window type, such as “double hung”, “casement”, “awning”, “picture”, “transom”, or other types of window. The graphical interface 1300 can also include a plurality of selectable options 1312 to specify a type of frame for the replacement window, such as a “Wood” frame, a “Metal” frame, a “Vinyl” frame, a “Fiberglass” frame, other types of frames, or any combination thereof. The graphical interface 1300 can include other selectable options 1314, such as buttons, pull-down menus, text fields, and so on (not shown). As the operator scrolls down to view and select the various options, a “Submit” button may be shown that can be selected by the operator to submit the selected parameters to the system.

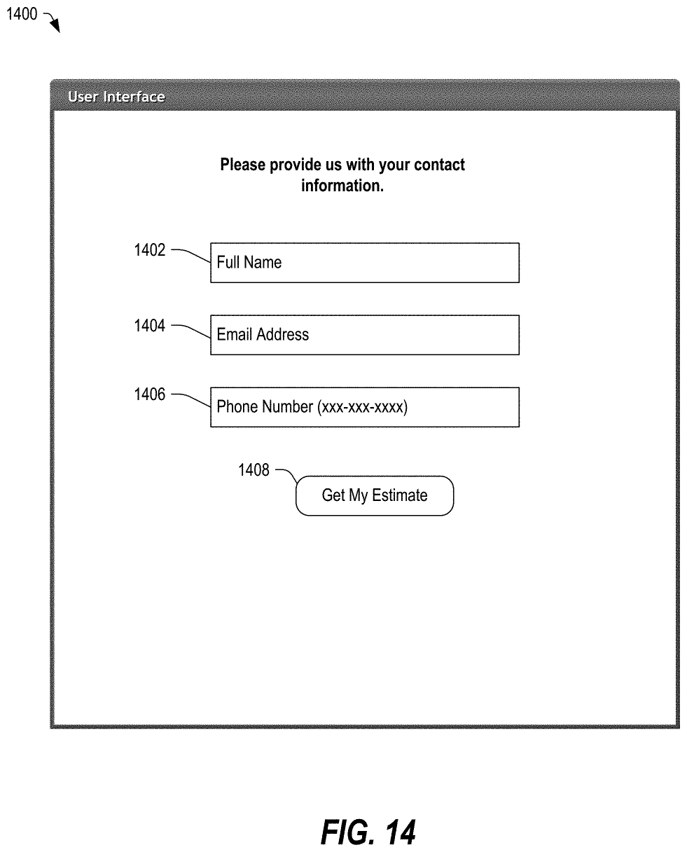

FIG. 14 depicts a graphical interface 1400 including selectable options accessible by an operator to provide contact information for the operator to receive an estimate, in accordance with certain embodiments of the present disclosure. In this example, upon selection of the “Submit” button in the graphical interface 1300, the graphical interface 1400 may include text fields 1402, 1404, and 1406 to acquire information about the operator. The text field 1402 may be configured to receive the operator's full name. The text field 1404 may be configured to receive the operator's email address. The text field 1406 may be configured to receive the operator's phone number 1406. The graphical interface 1400 can further include a “Get My Estimate” button 1408, which may be selected by the operator to initiate the request for an estimate. Other embodiments are also possible.

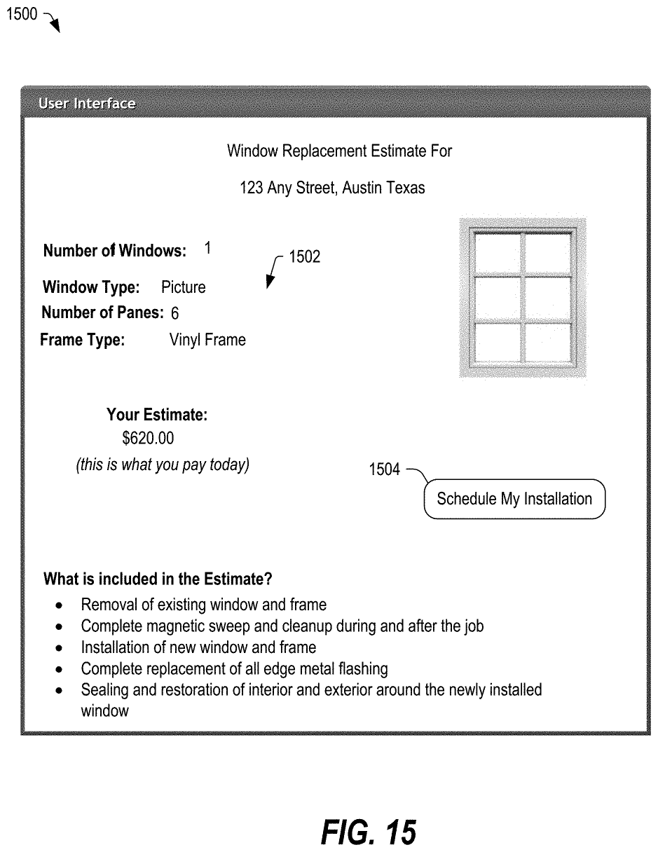

FIG. 15 depicts a graphical interface 1500 including details of an estimate for window replacement, in accordance with certain embodiments of the present disclosure. It should be appreciated that the graphical interface 1500 may include estimate details, generally indicated at 1502, and a “Schedule My Installation” button 1504 that can be accessed by the operator to schedule the window installation. Other embodiments are also possible.

It should be appreciated that the estimate depicted in the graphical interface 1500 represents one possible estimate. The estimate may be presented in an email, a text, a web page, or in a printed format. Other embodiments are also possible.

In conjunction with the systems, methods, and devices described above with respect to FIGS. 1-15, a device is disclosed that is configured to capture image data associated with a window to be replaced, to automatically determine dimensions of the window from the image data, to automatically determine costs associated with replacement or repair of the window based, at least in part, on the determined dimensions, and to provide an estimate. In an example, the device may be a smartphone or other portable computing device. In another example, the device may be a computer server that may capture the image data from a smartphone or other portable computing device. The dimensions of the window may be determined automatically based on the image and based on a reference object within the image. Alternatively, the dimensions of the window may be determined from a series of images taken in a sequence within a brief span of time, such as several milliseconds. Other embodiments are also possible.

Although the present invention has been described with reference to preferred embodiments, workers skilled in the art will recognize that changes may be made in form and detail without departing from the scope of the invention.

What is claimed is:

1. A system comprising:
a network interface configured to communicate with a network; and
a processor coupled to the network interface, the processor configured to:
receive image data corresponding to a window from a computing device via the network;
automatically determine dimensions of the window in response to receiving the image data;
automatically determine costs associated with repair or replacement of the window based on the determined dimensions; and
automatically provide an estimate for the repair or replacement of the window to the computing device through the network.

2. The system of claim 1, wherein the image data includes the window and a reference object having known dimensions.

3. The system of claim 1, wherein the image data includes a sequence of pictures, orientation data correlated to each picture of the sequence of pictures, and motion data correlated to each picture of the sequence of pictures.

4. The system of claim 3, wherein the processor automatically determines the dimensions of the window by:
automatically detecting changes in a relative position of the window within the sequence of pictures;
automatically determining a distance between the window and a camera that captured the sequence of images based on the detected chances, the orientation data, and the motion data; and
automatically determining the dimensions of the window based, in part, on the determined distance.

5. The system of claim 1, wherein the processor is further configured to provide a graphical interface to the computing device through the network, the graphical interface including selectable options and instructions to guide an operator through a process of capturing image data associated with the window.

6. The system of claim 1, wherein the processor is configured to automatically determine the costs by:
searching one or more data sources to retrieve material costs and labor costs;
applying the retrieved material costs to the determined dimensions to calculate material costs; and
combining the material costs and the labor costs to determine the costs associated with repair or replacement of the window.

7. The system of claim 1, wherein the processor is further configured to provide a graphical interface to the computing device through the network, the graphical interface including selectable options and including the estimate for the repair or replacement of the window.

8. A computing device comprising:
a camera; and
a processor coupled to the camera, the processor configured to:
control the camera to capture at least one image of a window;
automatically determine dimensions of the window based on the at least one image; and
automatically determine costs of repair or replacement of the window in response to determining the dimensions.

9. The computing device of claim 8, wherein the at least one image includes the window and a reference object of known dimensions.

10. The computing device of claim 8, further comprising:
a network interface coupled to the processor and configured to couple to a network; and
wherein the processor is configured to automatically determine the costs of repair or replacement of the window by:
sending data related to the determined dimensions to an automated window estimation system through the network; and
receiving the costs of repair or replacement of the window in response to sending the data.

11. The computing device of claim 8, wherein the at least one image includes a sequence of images.

12. The computing device of claim 11, further comprising:
an orientation sensor coupled to the processor and configured to generate orientation data corresponding to an orientation of the camera when each image of the sequence of images is captured;
a motion sensor coupled to the processor and configured to generate motion data corresponding to movement of the camera when each image of the sequence of images is captured; and
wherein the processor is configured to automatically determine the dimensions of the window by determining a distance between the window and the camera when each image is captured and by determining the dimensions of the window based on the distance.

13. The computing device of claim 8, wherein the camera and the processor are components of a smartphone.

14. The computing device of claim 8, further comprising:
a display coupled to the processor; and
wherein the processor is configured to providing a graphical interface to the display including the determined costs of repair or replacement and a selectable option accessible by an operator to schedule a repair or replacement of the window.

15. The computing device of claim 14, further comprising:
a network interface configured to couple to a network; and
wherein, in response to selection of the selectable option, the processor sends an alert to an automated window estimation system through the network to schedule the repair or replacement of the window.

16. A system comprising:
a computing device including:
a network interface configured to couple to a network;
a camera;
a display; and
a processor coupled to the network interface, the camera, and the display, the processor configured to:
capture image data associated with a window using the camera;
determine dimensions of the window based on the image data;
determine costs associated with repair or replacement of the window based on the determined dimensions; and
provide a graphical interface including the costs to the display.

17. The system of claim 16, wherein the image data includes the window and a reference object of known dimensions.

18. The system of claim 16, wherein the computing device further includes:
an orientation sensor coupled to the processor and configured to generate orientation data corresponding to an orientation of the camera when the image data is captured; and
wherein the processor is configured to determine the dimensions of the window based on changes in the image data correlated to the orientation data by determining a distance between the window and the camera and based on the image data.

19. The system of claim 16, wherein the processor determines the cost by searching one or more data sources through the network.

20. The system of claim 16, further comprising:
an automated window estimation system including:
a network interface coupled to the network; and
a processor coupled to the network interface and configured to:
receive data including the determined dimensions from the computing device through the network;
determine material costs and labor costs based on the received data; and
generate an estimate for repair or replacement of the window based on the determined material costs and the determined labor costs; and
send the graphical interface including the estimate to the computing device to be provided to the display.

21. The system of claim 16, wherein:
the graphical interface includes a selectable option accessible by the user to place one or more shape objects onto an image of the window, each shape object accessible by the user to resize the shape object onto the image; and
the processor configured to refine the determined dimensions to:
produce adjusted dimensions based on the one or more shape objects; and
adjust the determined costs to produce adjusted costs based on the adjusted dimensions.
